(19) United States
(12) Patent Application Publication
(10) Pub. No.: US 2005/0198033 A1
(43) Pub. Date: Sep. 8, 2005

(54) Method for moving data between folders within a data space

(76) Inventor: Fwad Malik, Mississauga (CA)

Correspondence Address: Ogilvy Renault, Suite 1600, 1981 McGill College Avenue, Montreal, QC, H3A 2Y3, CA

(21) Appl. No.: 10/771,510

(22) Filed: Feb. 5, 2004

(51) Int. Cl. G06F 17/30

(52) U.S. Cl. 707/10

(57) ABSTRACT

A method is provided for moving data from a source to a destination in a data space. The data space comprises an allotted portion of a memory having a predefined size limit. The method comprises the following steps. The allotted portion of the memory is increased. The data is copied from the source to the destination. The data is removed from from the source.

The present invention relates generally to data management protocols and specifically to a method for copying a message between folders within a data space when a quota for the data space is approached.

### BACKGROUND OF THE INVENTION

Internet Message Access Protocol (IMAP) is a standard client/server protocol in which an electronic mail (e-mail) message is received and stored on a mail server. Referring to FIG. 1, a client/server system architecture is illustrated generally by numeral 100. The system 100 comprises a server 102, a network 104, and a client 106. The server 102 is typically a mail server. The client is typically a computing device and can take the form of any of a plurality of known embodiments, including a desktop computer, a notebook computer, a personal digital assistant (PDA) or other handheld device, a cellular telephone, and the like. The network may include a plurality of interconnected network, including a Wireless Area Protocol (WAP) network, a General Packet Radio Services (GPRS) network, a Global System for Mobile communication (GSM) network, a Code-Division Multiple Access (CDMA), the Internet, a Plain Old Telephone System (POTS) and the like. The system illustrated in FIG. 1 and variations thereof are well known in the art and, therefore, need not be described in detail.

IMAP enables the client 106 to access messages from the mail server 102. The client 106 displays select message details to a user. Such select details may include the message subject line, sender name, received date, and the like. The user can then decide whether or not to retrieve the message from the mail server 102.

Further, IMAP enables the user to create and manipulate folders or mailboxes on the mail server 102, delete messages from the mail server 102, and search for messages on the mail server 102 using keywords. Generally, a mailbox is a data space in which electronic messages to and from a user may be stored. Thus, for optimal performance, IMAP requires continual access to the mail server 102 while the user is working with messages.

Since all messages are stored on the mail server 102 until they are deleted, quotas are often assigned to the users to limit the size of their mailboxes on the mail server 102. Reasons for implementing a quota vary but generally result from a large number of users leaving a large number of messages on the mail server 102. Having a large number of messages on the mail server 102 can rapidly consume available space and may even adversely affect the performance of the mail server 102.

However, the use of quotas has accentuated a shortcoming of IMAP. Specifically, the problem relates to the way in which messages are moved. In order to move a message, the message is first copied to a new location. The original message is marked for deletion, and then deleted. If, however, the size of the message to be copied is larger than the remaining mailbox space in accordance with the quota, then the message cannot be copied to its new location. This failure causes the transaction to fail and the message is not moved.

A current solution to the problem is to provide the user with a notification that the mailbox is full and to request that the user delete unwanted messages to increase the space availability of the mailbox. Once enough messages have been deleted from the mailbox, the move request will succeed. However, the user may have to attempt moving the message several times before actually freeing up enough space in the mailbox so that the move can be successfully performed.

The current solution is problematic since it is inconvenient for the user to repeatedly delete messages and retry the move until it can be performed. Further, users are required to delete messages even if they do not exceed their quota, which reduces the effective space available to the user.

### SUMMARY OF THE INVENTION

In accordance with an aspect of the invention, there is provided a method for moving data from a source to a destination in a data space, the data space comprising an allotted portion of a memory, the allotted portion having a predefined size limit. The method comprises the steps of increasing the allotted portion of the memory; copying the data from the source to the destination; and removing the data from the source.

In accordance with yet a further aspect of the invention, there is provided a computer program product for instructing a computing device to move data from a source to a destination in a data space, the data space comprising an allotted portion of a memory, the allotted portion having a predefined size limit. The computer program product comprises code for increasing the allotted portion of the memory; code for copying the data from the source to the destination; and code for removing the data from the source.

### BRIEF DESCRIPTION OF THE DRAWINGS

An embodiment of the present invention will now be described by way of example only with reference to the following drawings in which:

FIG. 1 is a diagram illustrating a client/server architecture (prior art);

FIG. 2 is a flow chart illustrating the operation of moving a message in accordance with an embodiment of the invention;

FIG. 3 is a flow chart illustrating the operation of moving a message in accordance with an alternate embodiment of the invention;

FIG. 4 is a flow chart illustrating the operation of moving a message in accordance with yet an alternate embodiment of the invention; and

FIG. 5 is a flow chart illustrating the operation of moving a message in accordance with yet an alternate embodiment of the invention.

### DETAILED DESCRIPTION OF THE PREFERRED EMBODIMENTS

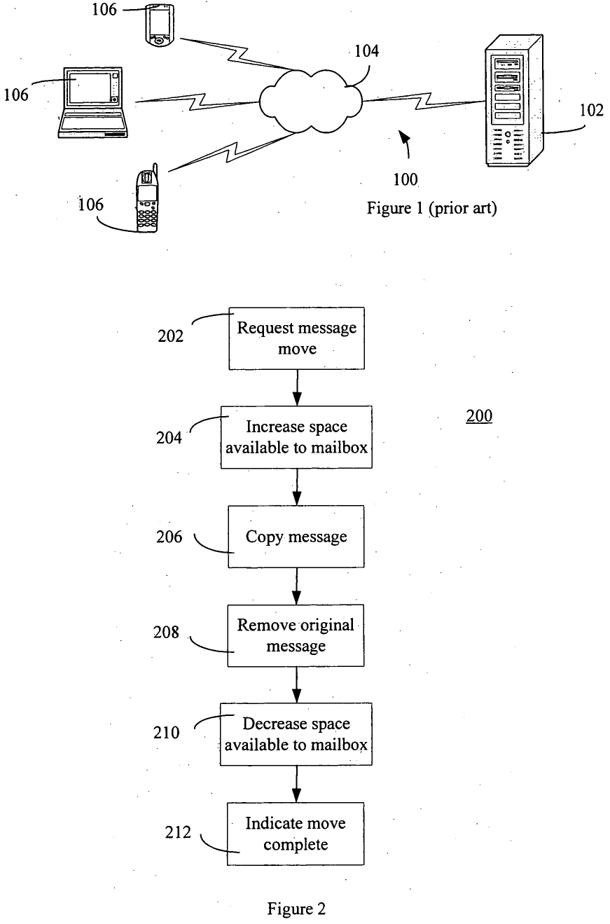

Referring to FIG. 2, a flow chart illustrating the operation of moving a message in accordance with an embodiment of the present invention is shown generally by numeral 200. In the present embodiment, the mail server 102 is an IMAP server.

In step 202 a request to move a message is sent from the client 106 to the mail server 102. The request typically moves a message between folders within a mailbox. In step 204, the mail server 102 increases the space available to the corresponding mailbox. In step 206, the mail server 102 copies the message to its destination folder. In step 208, the mail server 102 removes the original message. In step 210, the mail server 102 returns the space available to the mailbox to its original size. In step 212, the mail server 102 signals to the client 106 that the message has been successfully moved.

In the case of an error at any of the steps 202 to 212, the move operation is rolled back and all the steps that had successfully been performed are undone. Thus, in the event of an error, the state of the mailbox attempts to return to its state immediately prior to receiving the request at step 202. Further, the error is reported in accordance with standard error reporting procedures.

As described above in step 204, the mail server 102 increases the space available to the corresponding mailbox. In one embodiment, the mail server 102 increases the space available to the corresponding mailbox by removing the quota associated with the mailbox. Thus, in the following step 206 of copying the message, the server will not encounter the problem of the mailbox being too full. Accordingly, in step 210 the mail server 102 reapplies the quota before completing the operation 200.

However, in some mail servers 102, backup systems are implemented to ensure that a quota remains in effect. These systems will automatically reinstate the quota if they detect that it has been removed. Thus, the solution described in the previous embodiment may not work in certain circumstances. Accordingly, in an alternate embodiment, in step 204 the mail server 102 increases the space available to the corresponding mailbox by increasing the mailbox quota. The quota may be increased by as little as the space required to complete the operation or by as much as set by the mail server 102. Typically, little advantage is realized by more than doubling the size of the quota. For example, even in an extreme case where the entire quota is used by a single message, moving that message is possible if the quota has been doubled. Thus, in the following step 206 of copying the message, the server will not encounter the problem of the mailbox being too full. Accordingly, in step 210 the mail server 102 reduces the quota to its previous level before completing the operation 200.

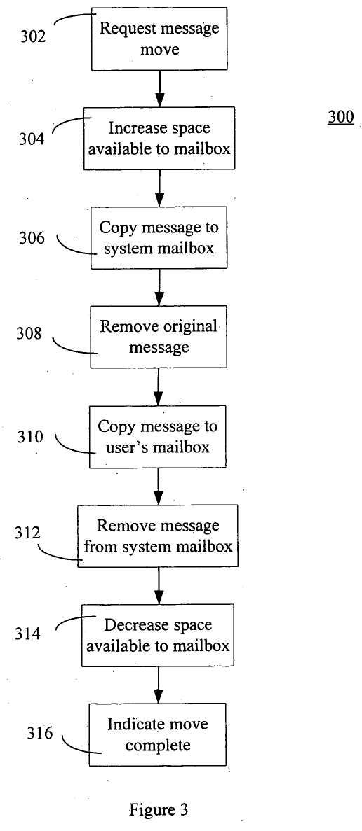

In yet an alternate embodiment, the mail server 102 increases the space available to the corresponding mailbox by allowing the mail server to copy the message to a system mailbox. The system mailbox typically has a large quota, or no quota at all. In the present embodiment, the operation of moving the message, illustrated in FIG. 3, differs slightly from the previous embodiments, illustrated in FIG. 2.

Referring to FIG. 3, a flow chart illustrating the operation of moving a message in accordance with the present embodiment is shown generally by numeral 300. In step 302 a request to move a message is sent from the client 106 to the mail server 102. In step 304, the mail server 102 increases the space available to the corresponding mailbox by allowing messages to be copied to the system mailbox. In step 306, the message to be moved is copied to the system mailbox. In step 308, the original message is deleted. In step 310, the message is copied from the system mailbox to the destination folder in the user's mailbox. In step 312, the message is deleted from the system mailbox. The operation then continues with step 314, in which the mail server 102 returns the space available to the mailbox to its original size. In the present embodiment the mailbox is considered to have returned to its original size since it is no longer using the space made available to it by the system folder. In step 316, the mail server 102 signals to the client 106 that the message has been successfully moved.

In the present embodiment, it is an option that the mail server prohibit the user's mailbox from receiving messages between step 308 and step 310. This option avoids a message from being received between steps 308 and 310, thus preventing the message from being written back to the user's mailbox due to quota limitations.

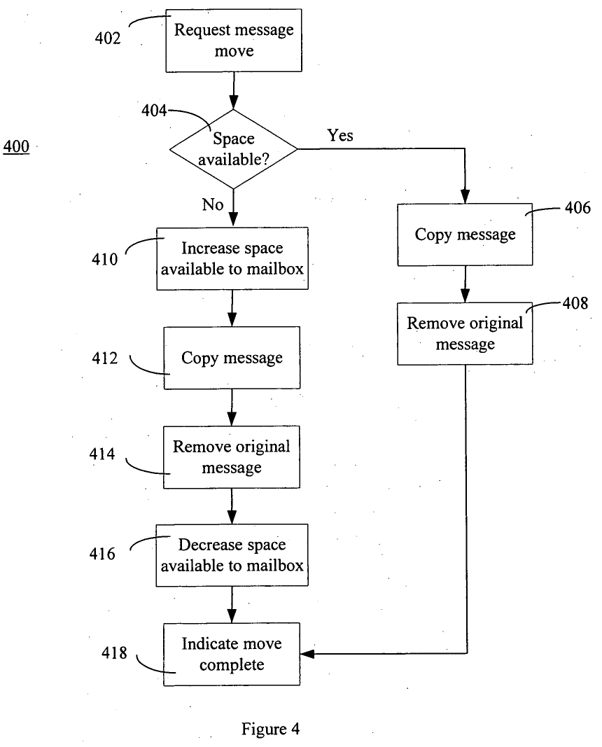

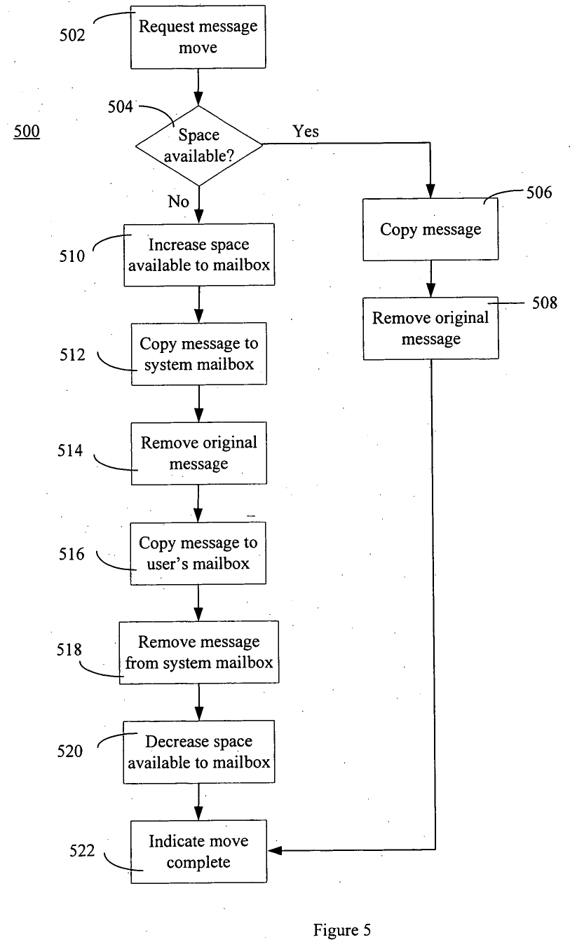

Yet further, all of the embodiments described above refer to situations where increasing the space available to the corresponding mailbox is the default regardless of how much space is available under the mailbox quota. In alternate embodiments, illustrated in FIGS. 4 and 5, the mail server 102 determines if there is enough space under the quota to move the message without having to adjust the space available to the mailbox.

Referring to FIG. 4, an alternate to the operation illustrated by FIG. 2 is shown generally by numeral 400. In step 402 a request to move a message is sent from the client 106 to the mail server 102. In step 404, the mail server 102 determines if there is enough space under the quota to move the message. If there is enough space, the operation proceeds to step 406, copying the message to its destination, and then to step 408, deleting the original message. After the message has been deleted, the operation proceeds to step 418, wherein the mail server 102 signals to the client 106 that the message has been successfully moved.

If, in step 404, the mail server 102 determines that there is not enough space, the operation proceeds to step 410. In step 410, the mail server 102 increases the space available to the corresponding mailbox. As described with reference to FIG. 2, this step comprises either removing the quota or increasing it. In step 412, the mail server 102 copies the message to its destination folder. In step 414, the mail server 102 removes the original message. In step 416, the mail server 102 returns the space available to the mailbox to its original size. As described with reference to FIG. 2, this step comprises either reapplying the quota or returning it to its original size. In step 418, the mail server 102 signals to the client 106 that the message has been successfully moved.

Referring to FIG. 5, an alternate to the operation illustrated by FIG. 3 is shown generally by numeral 500. In step 502 a request to move a message is sent from the client 106 to the mail server 102. In step 504, the mail server 102 determines if there is enough space under the quota to move the message. If there is enough space, the operation proceeds to step 506, copying the message to its destination, and then to step 508, deleting the original message. After the message has been deleted, the operation proceeds to step 522, wherein the mail server 102 signals to the client 106 that the message has been successfully moved.

If, in step 504, the mail server 102 determines that there is not enough space, the operation proceeds to step 510. In step 510, the mail server 102 increases the space available to the corresponding mailbox by allowing messages to be copied to the system mailbox. In step 512, the message to be moved is copied to the system mailbox. In step 514, the original message is deleted. In step 516, the message is copied from the system mailbox to the destination folder in the user's mailbox. In step 518, the message is deleted from the system mailbox. The operation then continues with step 520, in which the mail server 102 returns the space available to the mailbox to its original size. In the present embodiment the mailbox is considered to have returned to its original size since it is no longer using the space made available to it by the system folder. In step 522, the mail server 102 signals to the client 106 that the message has been successfully moved.

Although the embodiments have been described with reference to an IMAP server, it will be appreciated by a person of ordinary skill in the art that the invention may be applied to other protocols having a similar quota limitation. That is, when moving data from a source to a destination within a data space, errors arise as a result of size limitations placed on the data space. In the embodiments described herein, the source and destination are typically different folders and the data space is the mailbox.

It will be appreciated by a person of ordinary skill in the art that the previous descriptions are of preferred embodiments for implementing the invention, and the scope of the invention should not necessarily be limited by this description. Those of skill in the art may effect alterations, modifications and variations to the particular embodiments without departing from the scope of the application. The invention described herein is defined by the claim attached hereto and intend to cover and embrace all suitable changes in technology.

1) A method for moving data from a source to a destination in a data space, the data space comprising an allotted portion of a memory limited by a predefined size, the data being copied to the destination and being deleted from the source, the method characterized in that the allotted portion of the memory is increased to facilitate moving the data.

2) The method of claim 1, further comprising returning the allotted portion of the memory to its predefined size.

3) The method of claim 2, wherein increasing the allotted portion of the memory comprises removing the size limit and the step of returning the allotted portion of the memory to the predefined maximum size comprises reapplying the size limit.

4) The method of claim 2, wherein increasing the allotted portion of the memory comprises increasing the size limit and the step of returning the allotted portion of the memory to the predefined maximum size comprises decreasing the size limit to the predefined size limit.

5) The method of claim 4, wherein the size limit is increased such that it is at least large enough to permit the data to be moved.

6) The method of claim 4, wherein the size limit is doubled.

7) The method of claim 2, wherein increasing the allotted portion of the memory comprises enabling the data to be written to an alternate data space and the method further comprises:
copying the data from the source to the alternate data space; and
copying the data from the alternate data space to the destination;
wherein deleting the data from the source is performed between these additional steps.

8) The method of claim 1, wherein the source is a source folder, the destination is a destination folder, and the data space is a mailbox.

9) The method of claim 8, wherein the mailbox is managed in accordance with the Internet Message Access Protocol (IMAP).

10) A computer program product for instructing a computing device to move data from a source to a destination in a data space, the data space comprising an allotted portion of a memory limited by a predefined size, the data being copied to the destination and being deleted from the source, the computer program product characterized by code for increasing the allotted portion of the memory to facilitate moving the data.

11) The computer program product of claim 10 further comprising code for returning the allotted portion of the memory to the predefined size limit.

12) The computer program product of claim 11, wherein increasing the allotted portion of the memory comprises code for removing the predefined size limit, and returning the allotted portion of the memory to the predefined size limit comprises code for reapplying the predefined size limit.

13) The computer program product of claim 11, wherein increasing the allotted portion of the memory comprises code for increasing the size limit beyond the predefined size limit, and returning the allotted portion of the memory to the predefined maximum size comprises code for decreasing the size limit to the predefined size limit.

14) The computer program product of claim 13, wherein the size limit is increased such that it is at least large enough to permit the data to be moved.

15) The computer program product of claim 13, wherein the size limit is doubled.

16) The computer program product of claim 11, wherein increasing the allotted portion of the memory comprises code for enabling the data to be written to an alternate data space and the computer program product further comprises:
code for copying the data from the source to the alternate data space; and
code for copying the data from the alternate data space to the destination;
wherein removing the data from the source is executed between the additional code.

17) The computer program product of claim 10, wherein the source is a source folder, the destination is a destination folder, and the data space is a mailbox.

18) The computer program product of claim 17, wherein the mailbox is managed in accordance with the Internet Message Access Protocol (IMAP).
